(19) United States
(12) Patent Application Publication
(10) Pub. No.: US 2009/0308190 A1
(43) Pub. Date: Dec. 17, 2009

(54) POWER TRANSMISSION APPARATUS FOR PRESS MACHINE

(75) Inventors: Kaoru Mizuno, Sagamihara-shi (JP); Nobuyoshi Maeda, Sagamihara-shi (JP)

Correspondence Address: DARBY & DARBY P.C., P.O. BOX 770, Church Street Station, New York, NY, 10008-0770, US

(73) Assignee: Aida Engineering, Ltd., Sagamihara-shi (JP)

(21) Appl. No.: 12/475,659

(22) Filed: Jun. 1, 2009

(30) Foreign Application Priority Data
Jun. 13, 2008 (JP) 2008-155674

(51) Int. Cl. F16H 3/08; F16H 63/02

(52) U.S. Cl. 74/325; 74/335

(57) ABSTRACT

A power transmission apparatus for press machine according to the invention transmits rotational power from a drive shaft to a driven shaft. The apparatus has at least two drive gears arranged along an axial direction and substantially integrally attached to the drive shaft, a driven gear substantially integrally attached to the driven shaft, and an idle gear rotatably supported on an idle shaft and having a gear meshing with the driven gear and a plurality of gears corresponding respectively to the at least two drive gears. The idle gear can be displaced relative to the drive gear along the axial direction of the idle shaft to cause one of the at least two drive gears and corresponding one of the plurality of gears of the idle gear to mesh with each other selectively.

### CROSS-REFERENCE TO RELATED APPLICATION

This application claims the benefit under 35 U.S.C. §119 of Japanese Patent Application No. 2008-155674, filed on Jun. 13, 2008, which is hereby incorporated by reference herein in its entirety.

### FIELD OF THE INVENTION

The present invention relates to a power transmission apparatus for press machine, that is, for example, a power transmission apparatus that transmits rotation between a driving part (e.g. a fly wheel in which rotational energy is stored) and a driven part (e.g. a drive shaft for driving a slide) and can switch the reduction gear ratio (change gear ratio) among specific ratios.

### BACKGROUND

A power transmission apparatus of this type is described in, for example, Japanese Utility Model Application Laid-Open No. S55-77600. As shown in FIG. 5, this apparatus has a sliding gear 19 having an inner cylindrical portion that is spline-fitted (with spline grooves 15 and 16) on the outer circumference of a drive shaft 12 so that the sliding gear 19 is movable in the axial direction relative to the drive shaft 12 but rotation of the sliding gear 19 relative to the drive shaft 12 is restricted. The apparatus also has first and second gears 20, 21 that are provided substantially integrally with a driven shaft 23. In this apparatus, switching between a state in which a gear 17 provided on the sliding gear 19 and the second gear 21 mesh with each other and a state in which a gear 18 provided on the sliding gear 19 and the first gear 20 mesh with each other can be achieved by driving a hydraulic cylinder (or actuator) 30 provided at an end of the drive shaft 12 with respect to the axial direction to move the sliding gear 19 along the axial direction of the drive shaft 12. Thus, the reduction gear ratio in driving force transmission between the drive shaft 12 and the driven shaft 23 can be switched among specific ratios.

The reason why the reduction gear ratio between the drive shaft and the driven shaft is to be changed in the power transmission apparatus of the press machine is as follows. If the reduction gear ratio is fixed, for example in the case where press working is performed using a rotation energy stored in a fly wheel, if the press working is performed at a speed in the low speed range (i.e. low strokes-per-minute (SPM) range) with a reduction gear ratio that is suitable for press working speeds in the high speed range (high SPM range), the time taken to store energy required to perform the next press operation increases gradually due to insufficient energy. Thus, successive press operations cannot be performed at a desired SPM (this is because use of a reduction gear ratio suitable for the high speed range leads to a significant decrease in the available energy in the low speed range), and press working that requires high energy cannot be performed practically.

In such cases, if the reduction gear ratio can be switched to a ratio that is suitable for press working speeds in the low speed range (low SPM range), energy required in the press operation in the low speed range (low SPM range) can be provided. Thus, successive press operations can be performed with a desired energy also in the low speed range, whereby favorable energy supply can be achieved over a wide speed range, and a demand for a wide range of SPM can be met. In the case where a servo motor is used as the drive source without the use of a fly wheel also, switching of the reduction gear ratio enables driving the servo motor in a high efficiency operation range and can facilitate reduction in the volume of the servo motor.

For the above described reason, switching of the reduction gear ratio in transmission between the drive shaft and the driven shaft is required to be achieved.

In the apparatus described in Japanese Utility Model Application Laid-Open No. S55-77600, sliding gear 19 is externally fitted on the outer circumference of the drive shaft 12 by spline engagement so that the sliding gear 19 is movable in the axial direction relative to the drive shaft 12 but rotation of the sliding gear 19 relative to the drive shaft 12 is restricted. Machining of spline grooves 15, 16 provided on the outer circumference of the drive shaft 12 and the inner cylindrical portion of the sliding gear 19 for the spline engagement is not easy, and the use of the spline fitting leads to an increase in the machining cost and production cost, as a matter of fact.

In addition, the hydraulic cylinder (or actuator) 30 provided on the end of the drive shaft 12 requires a relatively large space with respect to the axial direction of the drive shaft 12 (i.e. the horizontal direction in FIG. 5), which can lead to a decrease in the degree of freedom in its arrangement.

Furthermore, since the hydraulic cylinder (or actuator) 30 is integrally attached to the drive shaft 12, the hydraulic cylinder (or actuator) 30 also rotates or turns with the rotation of the drive shaft 12. Thus, they have a large moment of inertia (GD²). This leads to a large rotational energy consumption at the time of starting the drive, and stopping of the rotation may be difficult.

### SUMMARY OF THE INVENTION

The present invention has been made in view of the above described situations and has as an object to provide a power transmission apparatus for press machine that can transmit rotation between a drive part and a driven part with predetermined switchable reduction gear ratios while having a simple, cost-efficient, and easy-to-manufacture structure that can be implemented in a small space.

A power transmission apparatus for press machine according to the present invention is an apparatus that transmits rotational power from a drive shaft to a driven shaft and includes:

at least two drive gears arranged along an axial direction and substantially integrally attached to the drive shaft;

a driven gear substantially integrally attached to the driven shaft; and

an idle gear rotatably supported on an idle shaft and having a gear meshing with the driven gear and a plurality of gears corresponding respectively to the at least two drive gears,

wherein the idle gear can be displaced relative to the drive gear along the axial direction of the idle shaft to cause one of the at least two drive gears and corresponding one of the plurality of gears of the idle gear to mesh with each other selectively.

In the power transmission apparatus according to the present invention, a gear that meshes with the driven gear may be one of the plurality of gears of the idle gear.

The power transmission apparatus according to the present invention may further include a displacement device for displacing the idle gear relative to the drive gear along the axial direction of the idle shaft, the displacement device including a moving element that is moved along a direction substantially parallel to the axial direction of the idle shaft, wherein the moving element may be caused to act on the idle gear to displace the idle gear relative to the drive gear along the axial direction of the idle shaft.

In the power transmission apparatus according to the present invention, the moving element may have, at its end, a holding member that holds the idle gear from both sides with respect to the axial direction of the idle shaft, and a base portion of the moving element may be adapted to receive a driving force acting in the axial direction of the idle shaft, whereby the moving element is moved in a direction substantially parallel to the axial direction of the idle shaft.

In the power transmission apparatus according to the present invention, the driven shaft may be in rotating engagement with a crank mechanism that converts transmitted rotational power into reciprocating motion of a slide.

The present invention can provide a power transmission apparatus for press machine that can switch the reduction gear ratio in rotation transmission between a driving part and a driven part among specific ratios, while the apparatus has a simple and cost-efficient structure that is easy to manufacture and easy to implement in a small space.

### BRIEF DESCRIPTION OF THE DRAWINGS

FIG. 1 is a front view schematically showing a power transmission apparatus for press machine according to an embodiment of the present invention.

FIG. 2 is a view for illustrating the structure of a fork-like member in the apparatus according to the embodiment, where the fork-like member 140 and portions relevant thereto as seen from the direction indicated by arrow A in FIG. 1

FIG. 3 is a side view of the power transmission apparatus for press machine according to the embodiment as seen from the direction indicated by arrow B in FIG. 1.

FIG. 4 is a view of the power transmission apparatus for press machine according to the embodiment taken along line C-C in FIG. 1.

FIG. 5 is a cross sectional view showing an example of conventional power transmission apparatus for press machine.

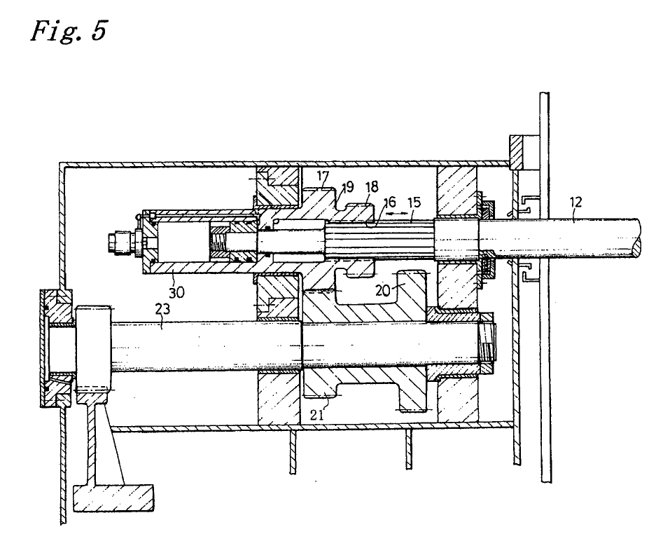

### DETAILED DESCRIPTION

In the following, an exemplary embodiment of the power transmission apparatus for press machine according to the present invention will be described with reference to the accompanying drawings. It should be understood that the present invention is not limited to the embodiment described below.

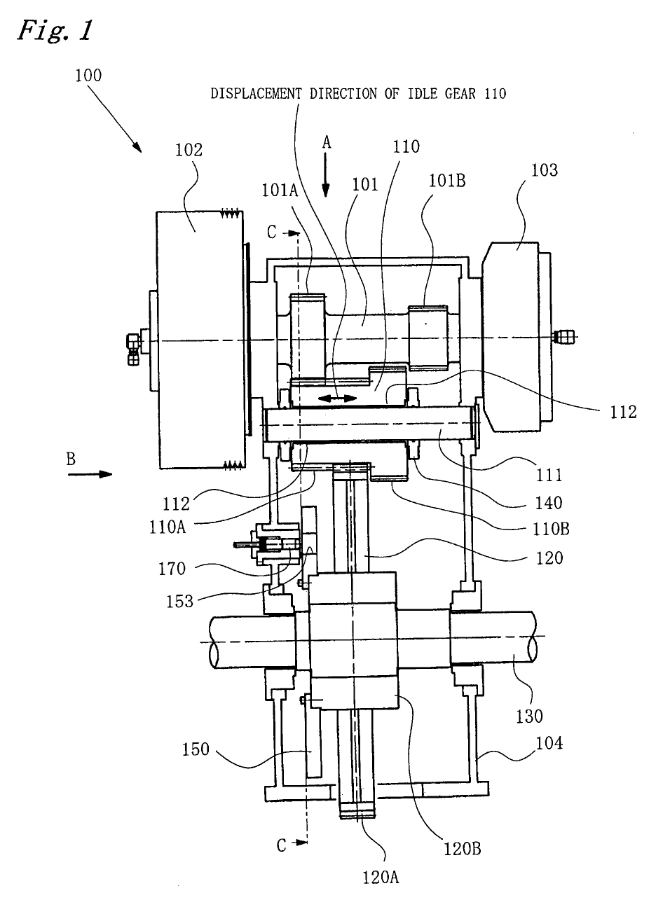

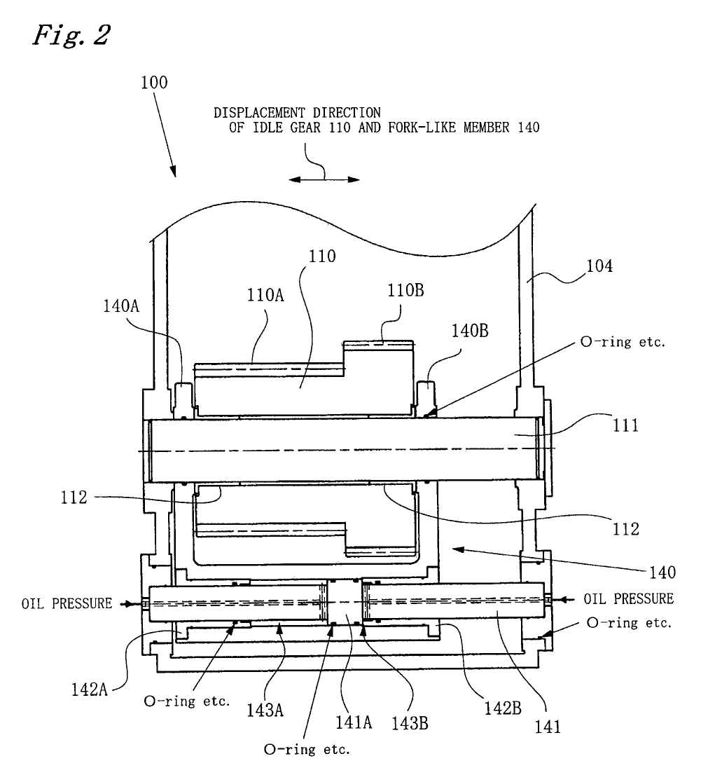

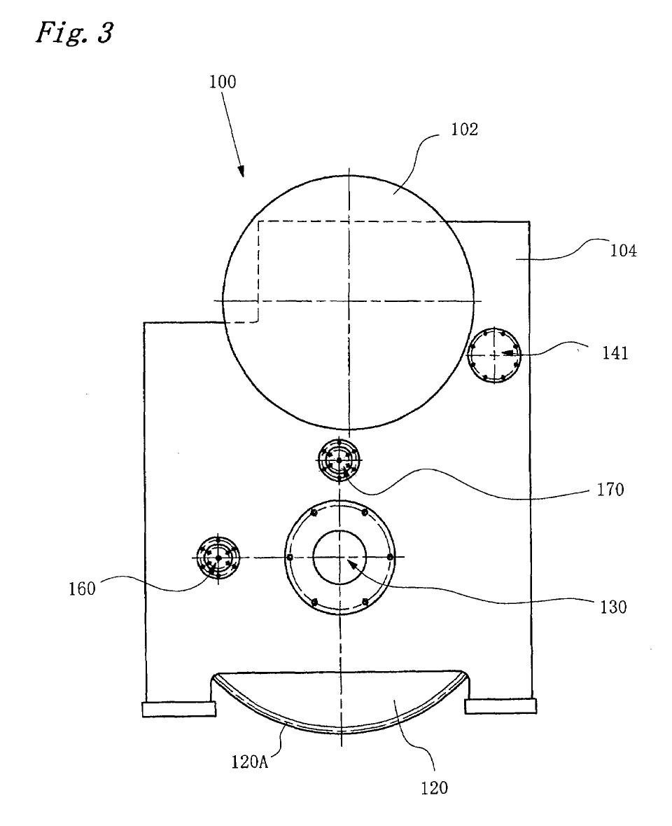

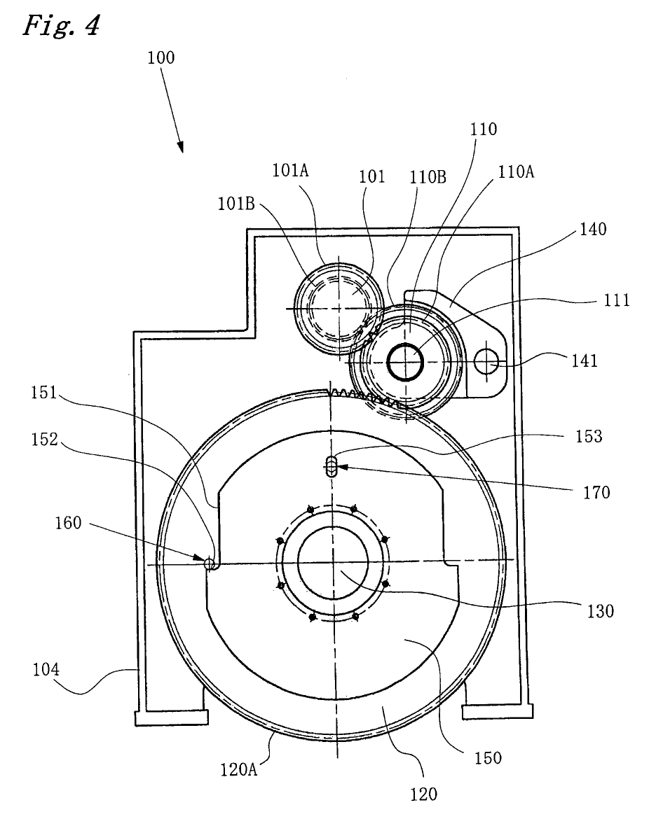

FIG. 1 is a front view of a power transmission apparatus 100 for press machine according to an embodiment. FIG. 1 shows portions relevant to the present invention, where some portions are cut away for illustration. FIG. 2 shows a fork-like member 140 that will be described later and the portions relevant thereto as seen from the direction indicated by arrow A in FIG. 1, for illustration of the structure of the fork-like member 140. FIG. 3 is a side view as seen from the direction indicated by arrow B in FIG. 1. FIG. 4 is a view taken along line C-C in FIG. 1.

On the left end (in FIG. 1) of a drive shaft 101 is attached a fly wheel 102 etc. The fly wheel 102 is rotationally driven by an electric motor or the like and stores rotation energy. Alternatively, the drive shaft 101 may be in rotating engagement with an output shaft of a servo motor without the fly wheel 102. The fly wheel 102 has a built-in clutch mechanism that enables/disables rotating engagement between the fly wheel 102 and the drive shaft 101.

On the right end (in FIG. 1) of the drive shaft 101 is provided a brake mechanism 103 for stopping rotation of the drive shaft 101.

The drive shaft 101 is provided with a high speed drive gear 101A and a low speed drive gear 101B. The drive shaft 101 is rotatably supported on a frame 104 by a bearing such as a roller bearing or a slide bearing. The high speed drive gear 101A and the low speed drive gear 101B have the same number of gear teeth but different modules. The phase of the teeth is also the same between the high speed drive gear 101A and the low speed drive gear 101B.

As shown in FIG. 1, the power transmission apparatus 100 for press machine according to the embodiment is provided with an idle gear 110 having a high speed idle gear 101A for meshing with the high speed drive gear 101A and a low speed idle gear 110B provided substantially integrally therewith.

The idle gear 110 is externally fitted and supported around the outer circumference of an idle shaft 111 by means of a slide bearing 112 (or a ball bearing) or the like in such a way as to be rotatable about and movable along the axis of the idle shaft 111. The idle shaft 111 is supported on the frame 104. The slide bearing or the like may be supplied with a lubricant such as lubricant oil.

While the high speed drive gear 101A of the drive shaft 101 and the high speed idle gear 110A of the idle gear 110 are spur gears having the same module and the same number of teeth, the low speed drive gear 101B of the drive shaft 101 and the low speed idle gear 110B of the idle gear 110 are spur gears having the same modules and different numbers of teeth. The distance between the axis of the drive shaft 101 and the axis of the idle shaft 111 is constant.

As shown in FIG. 1, the high speed idle gear 110A of the idle gear 110 meshes with a gear 120A (or spur gear) of a driven gear 120. A boss 120B of the driven gear 120 is substantially integrally mounted on a crankshaft 130 that converts rotational motion transmitted from the high speed idle gear 110A and the driven gear 120 into linear reciprocating motion of a slide (not shown) for press operation.

The power transmission apparatus 100 for press machine according to this embodiment is provided with a fork-like member 140 having bifurcated end portions 140A and 140B. The idle gear 110 is held between the end portion 140A and the end portion 140B. The end portions 140A, 140B are fitted and supported on the outer circumference of the idle shaft 111 in such a way that they can slide along the axial direction. The fork-like member corresponds to the moving element according to the present invention.

The base portion of the fork-like member 140 is fitted and supported on the outer circumference of a slide guide shaft 141 via sleeve members 142A, 142B. The slide guide shaft 141 has a partition portion 141A provided integrally therewith at a position near the center thereof. The sleeve member 142A and the partition portion 141A define a hydraulic chamber 143A therebetween, and the sleeve member 142B and the partition portion 141A defines a hydraulic chamber 143B therebetween.

The fork-like member 140 is adapted to be moved leftward and rightward in FIG. 2 along the slide guide shaft 141 in accordance with oil pressures supplied to the hydraulic chamber 143A and the hydraulic chamber 143B.

Specifically, when for example, the oil pressure (supplied from a hydraulic pump or the like that is not shown in the drawings) in the hydraulic chamber 143A is made higher than the oil pressure in the hydraulic chamber 143B, the volume of the hydraulic chamber 143B decreases, and the volume of the hydraulic chamber 143A increases, whereby the fork-like member 140 moves leftward in FIG. 2 along the slide guide shaft 141. (FIGS. 1 and 2 show a state in which the fork-like member 140 is at the leftmost position.)

On the other hand, when the oil pressure in the hydraulic chamber 143B is made higher than the oil pressure in the hydraulic chamber 143A, the volume of the hydraulic chamber 143A decreases, and the volume of the hydraulic chamber 143B increases, whereby the fork-like member 140 moves rightward in FIG. 2 along the slide guide shaft 141.

Thus, the base portion of the fork-like member 140, the slide guide shaft 141, the partition portion 141A, the sleeve members 142A, 142B etc. constitute a hydraulic actuator that causes the fork-like member 140 to reciprocate along the horizontal direction in FIG. 2. This hydraulic actuator corresponds to displacement means according to the present invention.

In the power transmission apparatus 100 for press machine according to this embodiment having the above described configuration, when the rotational energy stored in the fly wheel 102 etc. is to be transmitted to the crankshaft 130 to perform press operation, rotating engagement of the fly wheel 102 and the drive shaft 101 is enabled by the clutch mechanism etc. built in the fly wheel 102.

The drive shaft 101, to which the rotational energy of the fly wheel 102 has been transmitted, transmits the rotational energy to the idle gear 110 via the high speed idle gear 110A meshing with the high speed drive gear 101A as shown in FIGS. 1 and 4. The rotational energy is transmitted from the idle gear 110 to the driven gear 120 via the gear 120A meshing with the high speed idle gear 110A and further transmitted to the crankshaft 130.

As described above, when the press operations are performed at a speed in the high speed range (or high SPM range), the drive shaft 101 to which rotational energy of the fly wheel 102 has been transmitted transmits the rotational energy to the idle gear 110 via the high speed idle gear 110A meshing with the high speed drive gear 101A, and the rotational energy is transmitted from the idle gear 110 to the driven gear 120 via the gear 120A meshing with the high speed idle gear 110A and further transmitted to the crankshaft 130.

Therefore, when successive press operations are performed at a speed in the high speed range (or high SPM range), the reduction gear ratio between the drive shaft 101 and the driven shaft or the crankshaft 130 can be set to a value suitable for the high speed range. Therefore, the rotational energy of the fly wheel 102 can be transmitted efficiently to the crankshaft 130 in the high speed range, whereby high energy (or load) that enables successive press operations at a speed in the high speed range can be achieved, and insufficiency in energy in the high speed range is prevented. Thus, press operations can be performed at higher SPMs in the high speed range than in the case, for example, where the reduction gear ratio is fixed at a value that is suitable for a relatively low speed range.

In the power transmission apparatus 100 for press machine according to this embodiment, when successive press operations are to be performed, on the other hand, at a speed in the low speed range (or low SPM range), the reduction gear ratio between the drive shaft 101 and the driven shaft or the crankshaft 130 is switched from the reduction gear ratio suitable for the high speed range to a reduction gear ratio suitable for the low speed range. Specifically, the gears meshing between the drive shaft 101 and the idle gear 110 are changed by displacing the fork-like member 140 rightward in FIGS. 1 and 2 from the position shown in FIGS. 1 and 2.

More specifically, in the state shown in FIG. 1 where the high speed drive gear 101A of the drive shaft 101 and the high speed idle gear 110A of the idle gear 110 mesh with each other, the oil pressure in the hydraulic chamber 143B is made higher than the oil pressure in the hydraulic chamber 143A to increase the volume of the hydraulic chamber 143B, whereby the fork-like member 140 is displaced rightward in FIGS. 1 and 2. This causes the idle gear 110 to move rightward in FIGS. 1 and 2 along the idle shaft 111, whereby meshing of the low speed idle gear 110B of the idle gear 110 and the low speed drive gear 101B of the drive shaft 101 is achieved.

Thus, when successive press operations are performed at a speed in the low speed range (or low SPM range), the reduction gear ratio between the drive shaft 101 and the driven shaft or the crankshaft 130 can be set to a reduction gear ratio suitable for the low speed range during the press operations. Therefore, the rotational energy of the fly wheel 102 can be transmitted efficiently to the crankshaft 130 in the low speed range, whereby high energy (or load) that enables successive press operations in the low speed range can be achieved, and insufficiency in energy in the low speed range is prevented. Thus, press operations can be performed at higher SPMs in the low speed range than in the case, for example, where the reduction gear ratio is fixed at a value that is suitable for a relatively high speed range.

As described above, in the power transmission apparatus 100 for press machine according to this embodiment, since the reduction gear ratio between the drive shaft 101 and the crankshaft 130 (or the driven shaft) can be changed among specific ratios, rotational energy can be transmitted efficiently at a reduction gear ratio that is suitable for a required SPM. Therefore, efficient successive press operations can be achieved over a wide speed range including low speeds and high speeds.

Furthermore, in the power transmission apparatus 100 for press machine according to this embodiment, the drive shaft 101 and the crankshaft 130 (or the driven shaft) are adapted to be in rotating engagement via the idle gear 110 meshing with the drive shaft 101 and the crankshaft 130 (or the driven shaft). In addition, the idle gear 110 that rotates around the idle shaft 111 can be displaced along the direction of axis of the idle shaft 111 to change the meshing gear, whereby the reduction gear ratio between the drive shaft 101 and the crankshaft 130 (or the driven shaft) can be switched among predetermined ratios. Thus, machining of conventional spline can be eliminated, which can lead to a reduction in the machining cost, which in turn leads to a reduction in the production cost.

In this embodiment, changing of the reduction gear ratio is performed by the following process while the press operation is stopped. The drive shaft 101 is rotated, for example, at a relatively low rotation speed so as to rotate a positioning disk 150 that is coaxial with and substantially integrally mounted on the driven gear 120. When the positioning disk 150 assumes a certain rotational position, a positioning pin 160 extending in the axial direction of the crankshaft 130 is advanced toward the positioning disk 150 to enter the cut portion 151 of the positioning disk 150. Then, the positioning pin 160 comes into contact with the abutment portion 152 of the positioning disk 150 that is rotating, as shown in FIGS. 3 and 4. Simultaneously with the contact of the positioning pin 160 and the abutment portion 152, the driving of the drive shaft 101 is removed by the clutch mechanism built in the fly wheel 102.

In this state, where the abutment portion 152 and the positioning pin 160 are in contact with each other, another positioning pin 170 extending in the axial direction of the crankshaft 130 is advanced toward the positioning disk 150, so that the positioning pin 170 enters a positioning hole 153 provided on the positioning disk 150, whereby the rotational position relationship between the drive shaft 101 and the driven gear 120 is set to a specific position (which will be hereinafter referred to as the “reduction gear ratio changing position”) to thereby align the phases of teeth of the high speed drive gear 101A, the low speed drive gear 101B, the high speed idle gear 110A, and the low speed idle gear 110B.

In other words, when the aforementioned reduction gear ratio changing position is achieved, if the idle gear 110 is displaced rightward in FIG. 1 while the high speed drive gear 101A of the drive shaft 101 and the high speed idle gear 110A of the idle gear 110 mesh with each other, a specific tooth of the low speed drive gear 101B of the drive shaft 101 can enter between specific adjacent teeth of the low speed idle gear 110B of the idle gear 110. Therefore, if the aforementioned reduction gear ratio changing position is achieved, switching from meshing of the high speed drive gear 101A of the drive shaft 101 with the high speed idle gear 110A of the idle gear 110 to meshing of the low speed drive gear 101B of the drive shaft 101 with the low speed idle gear 110B of the idle gear 110 can be performed by displacing the idle gear 110 rightward in FIG. 1 along the idle shaft 111.

When the idle gear 110 is displaced along the idle shaft 111 as described above, it is necessary that the inner circumferential surface of the inner bore of the idle gear 110 and the outer circumferential surface of the idle shaft 111 allow smooth movement thereof along the axial direction. In this embodiment, the slide bearing 112 that supports the idle gear 110 in such a way as to allow its rotation relative to the idle shaft 111 also serves as bearing that allows axial displacement of the idle gear 110. Therefore, there is no need to provide an additional bearing for allowing the axial displacement of the idle gear 110.

This feature can facilitate a simplification of the structure, a reduction in the size and weight, and a reduction in the cost.

As described in the foregoing, in the power transmission apparatus 100 for press machine according to this embodiment, since the reduction gear ratio between the drive shaft 101 and the crankshaft 130 (or driven shaft) can be switched between specific ratios, rotational energy can be transmitted efficiently at a reduction gear ratio suitable for a required SPM. This enables efficient, successive press operations over a wide speed range including low speeds and high speeds.

According to the power transmission apparatus 100 for press machine of this embodiment, machining of spline used in conventional apparatuses can be eliminated, which can lead to a reduction in the machining cost, which in turn leads to a reduction in the production cost.

Furthermore, in the power transmission apparatus 100 for press machine of this embodiment, the actuator serving as the drive source for moving the idle gear 110 when changing the reduction gear ratio by displacing the idle gear 110 along the axial direction is disposed substantially side-by-side with the idle shaft 110. Therefore, the space required to provide the drive shaft can be made smaller with respect to the axial direction (i.e. the horizontal direction in FIGS. 1 and 2) as compared to conventional apparatuses in which a hydraulic cylinder (or actuator) is provided at an end of the drive shaft. Thus, a possible decrease in the degree of freedom in the configuration can be prevented.

In other words, according to this embodiment, it is not necessary to dispose the actuator adjacent to the drive shaft with respect to the axial direction (or horizontal direction), which affects the line length, but the actuator can be disposed adjacent to the drive shaft with respect to, for example, the vertical direction, which does not affect the line length and facilitates a reduction in the space occupied by it. This is advantageous in implementing the apparatus.

Furthermore, the structure of the power transmission apparatus 100 for press machine according to this embodiment is different from conventional apparatuses in which the actuator is integrally mounted on the drive shaft and rotates with the drive shaft. Therefore, the moment of inertia (GD²) of the drive shaft 101 can be made small in the apparatus of this embodiment, whereby energy consumption at the time of starting the apparatus can be made smaller and the rotation of the drive shaft can be stopped quickly.

Although the exemplary embodiment described in the foregoing is provided with a fly wheel 102, the present invention is not limited to this particular feature. The present invention can also be applied to a servo press machine in which rotational energy of a servo motor or the like is directly transmitted to a drive shaft without the use of a fly wheel.

Although the reduction gear ratio is switched among two different reduction gear ratios in the above-described embodiment, the present invention is not limited to this. The drive shaft 101 and the idle gear 110 may each be provided with a plurality of gears among which meshing gears are selected as desired, whereby the reduction gear ratio can be switched among three or more reduction gear ratios.

Other various modifications can be made to the apparatus without departing from the spirit and scope of the present invention.

### INDUSTRIAL APPLICABILITY

According to the power transmission apparatus for press machine according to the present invention, the reduction gear ratio in transmission of rotation between a drive part and a driven part can, advantageously, be switched among specific ratios while the apparatus has a simple and cost-efficient structure that is easy to manufacture and easy to implement in a small space.

What is claimed is:

1. A power transmission apparatus for press machine that transmits rotational power from a drive shaft to a driven shaft, comprising:
at least two drive gears arranged along an axial direction and substantially integrally attached to the drive shaft;
a driven gear substantially integrally attached to the driven shaft; and
an idle gear rotatably supported on an idle shaft and having a gear meshing with said driven gear and a plurality of gears corresponding respectively to said at least two drive gears, wherein
said idle gear can be displaced relative to said drive gear along the axial direction of the idle shaft to cause one of said at least two drive gears and corresponding one of the plurality of gears of said idle gear to mesh with each other selectively.

2. A power transmission apparatus for press machine according to claim 1, wherein a gear that meshes with said driven gear is one of the plurality of gears of said idle gear.

3. A power transmission apparatus for press machine according to claim 1, further comprising displacement means for displacing said idle gear relative to said drive gear along the axial direction of the idle shaft, the displacement means including a moving element that is moved along a direction substantially parallel to the axial direction of the idle shaft, wherein the moving element is caused to act on said idle gear to displace said idle gear relative to said drive gear along the axial direction of the idle shaft.

4. A power transmission apparatus for press machine according to claim 2, further comprising displacement means for displacing said idle gear relative to said drive gear along the axial direction of the idle shaft, the displacement means including a moving element that is moved along a direction substantially parallel to the axial direction of the idle shaft, wherein the moving element is caused to act on said idle gear to displace said idle gear relative to said drive gear along the axial direction of the idle shaft.

5. A power transmission apparatus for press machine according to claim 3, wherein said moving element comprises, at its end, a holding member that holds said idle gear from both sides with respect to the axial direction of the idle shaft, and a base portion of said moving element receives a driving force acting in the axial direction of the idle shaft, whereby the moving element is moved in a direction substantially parallel to the axial direction of the idle shaft.

6. A power transmission apparatus for press machine according to claim 4, wherein said moving element comprises, at its end, a holding member that holds said idle gear from both sides with respect to the axial direction of the idle shaft, and a base portion of said moving element receives a driving force acting in the axial direction of the idle shaft, whereby the moving element is moved in a direction substantially parallel to the axial direction of the idle shaft.

7. A power transmission apparatus for press machine according to claim 1, wherein said driven shaft is in rotating engagement with a crank mechanism that converts transmitted rotational power into reciprocating motion of a slide.

8. A power transmission apparatus for press machine according to claim 2, wherein said driven shaft is in rotating engagement with a crank mechanism that converts transmitted rotational power into reciprocating motion of a slide.
